(19) United States
(12) Patent Application Publication
(10) Pub. No.: US 2026/0182766 A1
(43) Pub. Date: Jul. 2, 2026

(54) Manual Juice Extraction Device

(71) Applicant: Leonardo Luis Quintero, Newark, NJ (US)

(72) Inventor: Leonardo Luis Quintero, Newark, NJ (US)

(21) Appl. No.: 19/007,596

(22) Filed: Jan. 2, 2025

(51) Int. Cl. A47J 19/02; A47J 19/00

(52) U.S. Cl. CPC A47J 19/023; A47J 19/005

(57) ABSTRACT

The disclosed device comprises a first section and a second section. The two sections joined together at first point with a pivot. The pivot causes the first and second sections to fold clam-shell style. The first section having a handle joining a concave aperture formed by a wall having a plurality of openings therethrough. The second section having a handle joining a convex section. The convex section further comprising a cutting-edge protruding outward. The handles of the first and second sections are preferably parallel and in a stacked configuration with each other when the first and second sections are folded, with the inner arc of the concave aperture patching the outer arc of the convex section. The concave aperture further comprising a slot for the cutting edge. The slot perforating the wall of the concave aperture without having the cutting edge protrude to the other side of the wall.

### FIELD OF INVENTION

The present invention relates to a juice extraction device, in particular to a manually operated device configured to extract juice for personal use, preferably from a single fruit at a time.

### BACKGROUND OF THE INVENTION

Juicing, or the process of extracting liquid by squeezing fruits can be done in a plurality of ways. Obtaining juice directly from the fruit is the most organic method of producing fruit juice and has many associated health benefits. For this reason, mankind have been coming up with various manually operated device to extract juice.

In Most cases, a fruit is pre-sliced, with slices or parts being subjected to crushing planes. To perform slicing a crushing, a user would need to engage in a two-step process and would require more than one tool, namely, a knife and a squeezer.

The market has realized this limitation and there have been efforts to combine the slicing and crushing steps into a single device. The resulting solutions have a number of limitations, with complexity being one of them. Complexity increases the cost of the device to manufacturer and consumer and actually decreases effectiveness, since additional parts generally lead to waste of pulp matter and reduced harvesting of liquid

### SUMMARY OF THE INVENTION

It is the object of the present disclosure to describe a new and non-obvious device for extracting liquid from fruits and vegetables.

It is another object of the present disclosure to describe a device that is capable of maximize the volume of extracted juices.

It is still another object of the present disclosure to describe a new manually operated juice extraction device.

It is still another object of the present disclosure to describe a manually operated fruit crusher which adds a slicer to improve the efficiency and totality of liquid extraction.

It is still another object of the present disclosure to describe a manually operated fruit crusher which adds a slicer to improve juice removal and provides openings to drain extracted liquid.

The disclosed device is comprised of a first section and a second section. The two sections joined together at first point with a pivot. The pivot causes the first and second sections to fold clam-shell style. The first section having a handle joining a concave aperture, with the concave aperture also having a plurality of openings through the wall of the concave aperture. The second section having a handle joining a convex section. The convex section further comprising a cutting-edge protruding outward. The handles of the first and second sections are preferably parallel and in a stacked configuration with each other when the first and second sections are folded, with the inner arc of the concave aperture patching the outer arc of the convex section. The concave aperture further comprising a slot for the cutting edge. The slot perforating the wall of the concave aperture without having the cutting edge protrude to the other side of the wall

### BRIEF DESCRIPTION OF DRAWINGS

FIG. 1 is a sideview of the disclosed device in a closed configuration according to one embodiment.

FIG. 2 is a sideview of the disclosed device in an open configuration according to one embodiment.

FIG. 3 is the top view of the disclosed device according to one embodiment.

FIG. 4 is a sideview of the disclosed device showing first and second sections in an opened configuration according to one embodiment.

FIGS. 4A and 4B demonstrating the cutting edge of the disclosed device according to one embodiment.

FIG. 5 is a side view of the disclosed device in a closed configuration according to one embodiment.

FIG. 6 is an exploded view of separated components of the disclosed device according to one embodiment.

FIG. 7 is an additional embodiment of the disclosed device shown in an exploded view

### DETAILED DESCRIPTION OF THE INVENTION

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

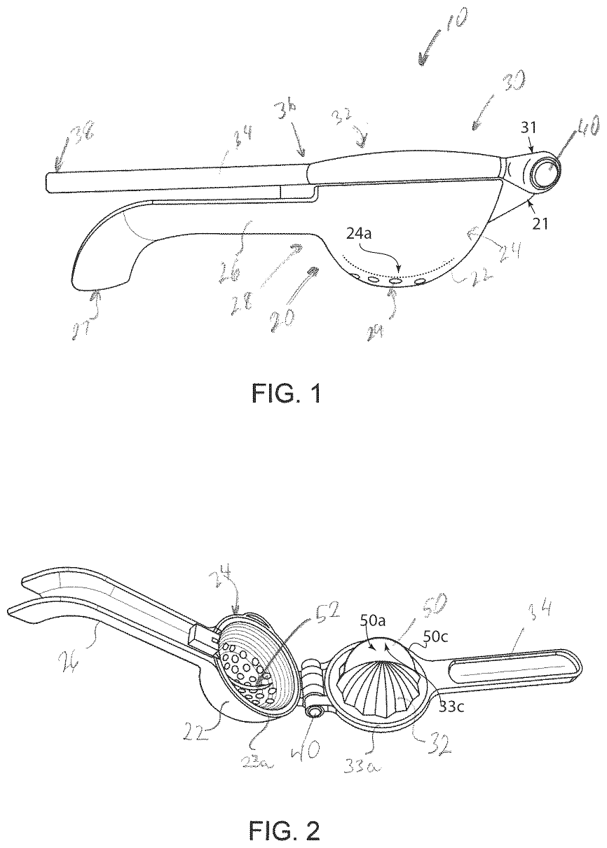

Turning now descriptively to the drawings, and in particular to FIGS. 1 and 2, as well as to other and rest of the disclosed figures, in which similar reference characters denote similar elements throughout the several views, the figures illustrate a manual liquid extraction device 10 according to one embodiment, comprising: a first section 20 and a second section 30. The first section 20 having a handle 26 with a free end 28 connecting to a concave aperture 24. The second section 30 is shown having a handle 34, with a distal end 38 and a free end 36 connecting to the convex section 32. Both the handle 26 with the concave aperture 24 and the handle 34 with the convex section 32 are preferably in a linear association with the first and second sections 20 and 30, respectively, being substantially parallel and in stacked configuration with respect to one another. The distal end 27 of the handle 26 may be curved to provide additional stability while laying on a support surface or a secure handhold during the squeeze operation.

The first end 21 of the first section 20 and the first end 31 of the second section 30 joined together with a pivot 40, which is preferably a hinge. The pivot 40 is configured to cause the first and second sections 20 and 30, respectively, to fold in a clamshell style—i.e., to fold into a closed position. The convex section 32 is configured to enter into concave aperture 24 when the second section 30 and the first section 20 are moved into the closed position. Preferably, the convex section 32 is configured to be fully submergible within the concave aperture 24 until the flange 33a that marks the circumference around the convex section 32 comes into contact with the rim 23a of the wall 22 forming the concave aperture 24.

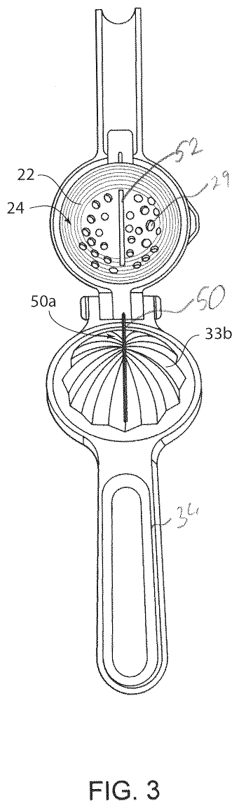

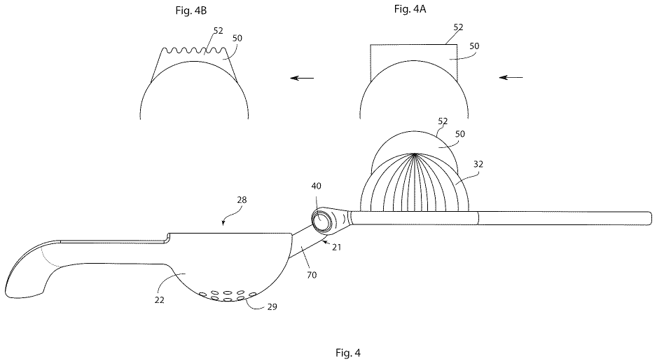

Further shown in FIG. 2 is the cutting edge 50, which is substantially a blade having a cutting area 50a and an edge 50c protruding outwardly from the wall 33b (FIG. 3) marking the convex section. The cutting edge 50 is located substantially along the middle or at the apex of the arch 33c of the convex section 32. The cutting edge 50 is configured to cut a fruit or vegetable placed inside the concave aperture 24 into at least two halves. Once the fruit or vegetable has been sliced, the cutting edge 50 becomes fully submerged within the slot 52 that dissects the wall 22.

As shown in FIG. 3 the fruit or vegetable is then engaged and crushed by the wall 33b against the wall 22. The liquid extracted from the cut and crushed fruit then drains through the plurality of openings 29 and the slot 52 perforating the wall 22 of the concave aperture 24. The thickness of the wall 22 is preferably sufficient to fully conceal the cutting area 50a and thus prevent the edge 52 from protruding through to the other side. The wall 22 and the wall 33b may made of uneven or textured surfaces as shown or may be made in flat or smooth surface. It is also preferred that the arch 33c of the convex section 32 is substantially equal to the arch 24a (FIG. 1) of the concave aperture 24.

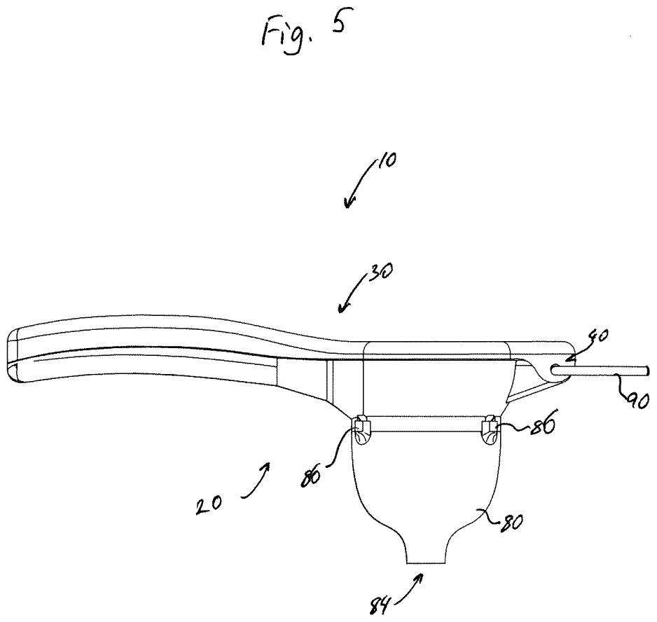

FIG. 4 shows the first section 20 and the second section 30 full unfolded over the pivot 40. Notably the first end 21 of the first section is further comprised of a diagonal extension 70 that extends substantially from the rim 23a towards the pivot 40. Also shown in FIGS. 4A and 4B the various types of cutting edge 50 that may be used, such as but not limited to a halfmoon edge 52, a flat or square edge as shown in FIG. 4A or a jagged or serrated edge as shown in FIG. 4B. Additionally, the blades 50 may be removable or the entire convex section 32 may be removable to be replaced with sections having different blade types or having additional blades. It should be noted further that while one blade 50 is shown, other embodiments may implement additional blades that may be oriented in parallel to each other or in intersecting configuration.

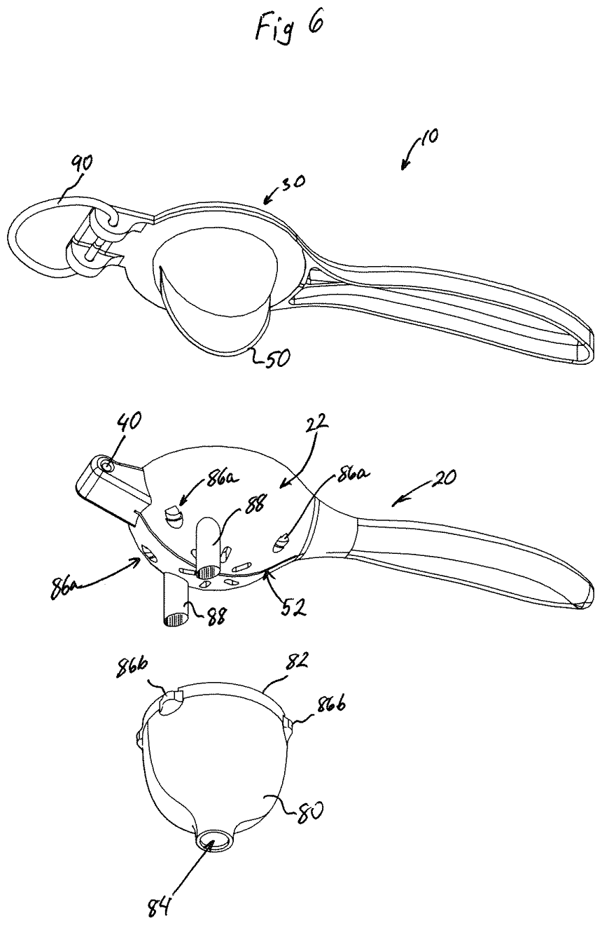

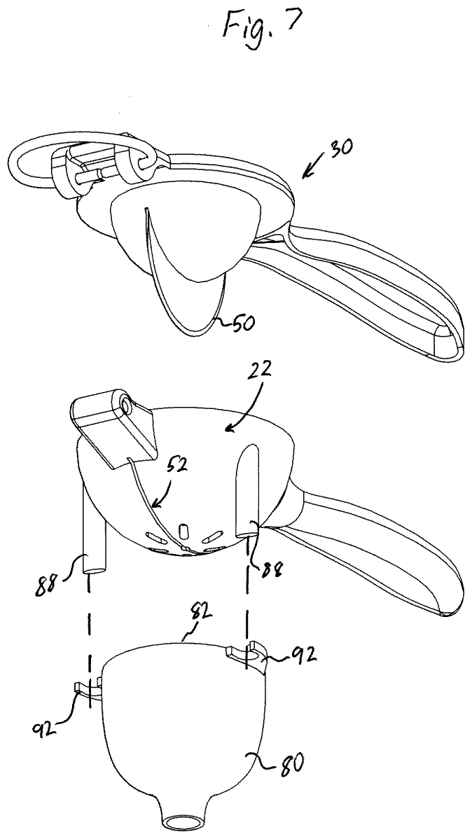

FIGS. 5 and 6 shows a manual liquid extraction device 10 according to one embodiment, comprising a first section 20, a second section 30, a funnel 80. The first section 20 and second section 30 are similar to the first section 20 and second section 30 described above in the earlier embodiment(s).

The funnel 80 is coupled to the first section 20. The funnel 80 is a cap at the bottom of the device 10, which directs all extruded juices through a single central (lower) opening 84. Funnel 80 has an upper rim 82, a lower (or central) opening 84, and an interior space disposed between the upper rim 82 and the lower opening 84.

FIGS. 5 and 6 show an embodiment in which the funnel 80 is releasably coupled to the first section 20 (i.e., the funnel 80 is removable). In this embodiment, a fastening mechanism 86 is provided for securing the first section 20 with the funnel 80. The fastening mechanism 86 is a two-part mechanism, comprising a plurality of first fastening members 86a (i.e., one-half of the two-part mechanism) and a plurality of second fastening members 86b (i.e., the other half of the two-part mechanism). The first fastening members 86a are arranged along the underside (i.e., outer surface) of the wall 22. The second fastening members 86b are arranged along the funnel 80 proximate to the upper rim 82 of the funnel 80.

In the embodiment shown in FIGS. 5 and 6, the first fastening members 86a comprise fastening tongues and the second fastening members 86b comprise fastening sleeves. Each of the second fastening members 86b has a top opening having a width and a bottom opening having a width and is configured to receive at least a portion of a respective one of the first fastening members 86a. Each one of the first fastening members 86a releasably engages a corresponding one of the second fastening members 86b. Each one of the first fastening members 86a has a compressible distal end having an initial width prior to compression/contracting and a contracted width during contraction. Each one of the first fastening members 86a contracts from one or both lateral sides when it is forced through the top end of the second fastening member 86b, or is manually contracted by the user prior to insertion into the second fastening member 86b, and the one or both lateral ends radially expand(s) as it exits the bottom opening of the second fastening member 86b (before or during insertion of the fastening tongue) and as it exists the top opening of the second fastening member 86b (during removal of the fastening tongue). The initial width of the distal end of the fastening tongue is greater than the width of the top and bottom openings of the fastening sleeve. The width of the top and bottom openings of the fastening sleeve is equal to, or greater than, the contracted width of the distal end of the fastening tongue. The one or both lateral sides of the first fastening member 86a are pinched or otherwise compressed in order to disengage and remove the first fastening member 86a from the second fastening member 86b.

In another embodiment (not shown in the figures), the fastening mechanism (86) comprises any conventional two-part locking mechanism, including, but not limited to, any one of the following mechanical locking mechanisms: a tuck (or buckle) lock mechanism, a bayonet locking mechanism, a snap-in locking mechanism (e.g., a snap-clamp mechanism, a hinge snap-lock mechanism or a non-hinged snap-lock mechanism), a push-pull (also known as push-fit or push-and-press) locking mechanism, a latch locking mechanism, a lever locking mechanism, or a screw-on mechanism (i.e., the underside of wall (22) and the upper rim (82) of the funnel (80) are coupled via a threaded connection), or a combination thereof.

In another embodiment, the funnel 80 is integrally formed with the first section 20. In another embodiment, the funnel 80 is secured to the first section 20 with a locking means that is not easily disengaged, such as, but not limited to, a screw lock mechanism.

In one embodiment, the lower (central) opening 84 functions as a base to support the device 10 on a flat surface when the first section 20 is uncoupled from the funnel 80.

FIG. 6 shows an exploded view of an embodiment in which first section 20 is further equipped with hollow pipes 88. Each one of the pipes 88 is in communication with one or more of the juice drain openings 29. In particular, the pipes 88 each have a top opening and a bottom opening. The top opening is in communication with the one or more juice drain openings 29. The bottom opening is an outlet to the interior space of the funnel 80. Accordingly, the extracted juice flows through pipes 88 and the additional drain openings 29 into the funnel 80.

In one embodiment, the pipes 88 also functions as feet to support the device 10 on a flat surface when the first section 20 is uncoupled from the funnel 80. FIG. 6 shown an embodiment containing two of the pipes 88. In this embodiment, the pipes 88 are configured and positioned to support the device 10 in an upright (i.e., horizontal) position when the first and second sections (20, 30) are in the closed position. In other embodiments, three or more of the pipes 88 are provided. It would be readily apparent to a person of ordinary skill in the art that the installation of additional pipes 88 provides more standing support for the device 10.

In one embodiment, a loop 90 is provided, having a portion of its perimeter passing through pivot 40 to connect the loop 90 to the second section 30. The loop 90 provides a convenient hand hold for carrying device 10 and also provides a means for suspending the device 10 on a hook or the like.

FIG. 7 discloses another embodiment, having the pipes 88 function as fastening member to couple with clamp brackets 92 of the funnel 80. The clamp brackets 92 are located substantially near the top rim 82 of the funnel 80 and are configured to be removably attached to the pipes 88 that are functioning as fastening members in this embodiment.

The following is a list of reference numerals and associated parts as used in this specification and drawings:

Although this invention has been described with a certain degree of particularity, it is to be understood that the present disclosure has been made only by way of illustration and that numerous changes in the details of construction and arrangement of parts may be resorted to without departing from the spirit and the scope of the invention. While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present disclosure may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims, as currently written or as amended or added in the future. Descriptions of exemplary methods or processes are not limited to inclusion of all steps as being required in all cases, nor is the order that the steps are presented to be construed as required or necessary unless expressly so stated

1. A manual liquid extraction device comprising: a first section, said first section having a handle joined to a concave aperture; a second section, said second section having a handle joined to a convex section; wherein a first end of said first section and a first end of said second section are joined together with a pivot; wherein said convex section is configured to enter said concave aperture when said first section and said second section are in a folded and stacked configuration; and wherein said convex section further comprises a protruding cutting edge.

2. The manual liquid extraction device of claim 1, wherein said concave aperture further comprises a slot, said slot perforating a wall forming said concave aperture, and wherein said slot is configured to conceal said cutting edge therein.

3. The manual liquid extraction device of claim 1, wherein said concave aperture further comprises a plurality of openings, said plurality of openings perforating a wall forming said concave aperture.

4. The manual liquid extraction device of claim 2, wherein said concave aperture further comprises a plurality of openings, said plurality of openings perforating a wall forming said concave aperture.

5. The manual liquid extraction device of claim 4, wherein said first end of said concave aperture further comprises a diagonal extension; and wherein said pivot joining said first end of said second section being disposed on a free end of said diagonal extension.

6. The manual liquid extraction device of claim 2, wherein said first end of said concave aperture further comprises a diagonal extension; and wherein said pivot joining said first end of said second section being disposed on a free end of said diagonal extension.

7. The manual liquid extraction device of claim 5, wherein said handle of said first section and said handle of said second section are configured to be in a parallel and stacked configuration.

8. The manual liquid extraction device of claim 6, wherein said handle of said first section and said handle of said second section are configured to be in a parallel and stacked configuration.

9. The manual liquid extraction device of claim 1, further comprising a funnel and a fastening mechanism for releasably coupling said funnel to said first section, said funnel having an interior space, an upper rim and a lower opening; wherein said concave aperture is formed of a wall having an inner surface and an outer surface; and wherein said upper rim of said funnel is releasably coupled to said outer surface of said wall.

10. The manual liquid extraction device of claim 9, wherein said fastening mechanism comprises a plurality of first fastening members arranged on said outer surface of said wall and a plurality of second fastening members arranged on said funnel proximate to said upper rim of said funnel.

11. The manual liquid extraction device of claim 10, wherein each one said first fastening members comprises a fastening tongue and each one said second fastening members comprises a fastening sleeve.

12. The manual liquid extraction device of claim 11, wherein said fastening sleeve comprises a top opening having a width and a bottom opening having a width; wherein a distal end of said fastening tongue is configured to contract from one or both lateral sides when being inserted into said top opening and to expand when exiting said top opening or said bottom opening; wherein said fastening tongue contracts from an initial state having an initial width to a contracted state having a contracted width; wherein said initial width is greater than said width of said top opening and said bottom opening; and wherein said width of said top opening and bottom opening is equal to or greater than said contracted width.

13. The manual liquid extraction device of claim 3, further comprising one or more pipes, each of one said pipes having a top opening and a bottom opening, said top opening in communication a corresponding one or more of said plurality of openings.

14. The manual liquid extraction device of claim 13, wherein said bottom opening of said pipes is an outlet to said interior space of said funnel.

15. The manual liquid extraction device of claim 9, further comprising one or more pipes, each one of said pipes having a top opening and a bottom opening; wherein said concave aperture further comprises a plurality of openings, said plurality of openings perforating a wall forming said concave aperture; and wherein said top opening is in communication with a corresponding one or more of said plurality of openings.

16. The manual liquid extraction device of claim 15, wherein said bottom opening of said pipes is an outlet to said interior space of said funnel.

17. The manual liquid extraction device of claim 1, further comprising two or more pipes configured to support said device in an horizontal orientation when said first section and said second section are in a closed position.

18. The manual liquid extraction device of claim 1, further comprising a loop 90, a portion of said loop passes through said pivot to connect said loop to said second section.

19. The manual liquid extraction device of claim 9, further comprising a loop 90, a portion of said loop passes through said pivot to connect said loop to said second section.
